(19) United States
(12) Patent Application Publication
(10) Pub. No.: US 2006/0059505 A1
(43) Pub. Date: Mar. 16, 2006

(54) Tuning apparatus and television receiver provided with the same

(76) Inventor: Hiroyuki Miyazaki, Fukui (JP)

Correspondence Address: FLYNN THIEL BOUTELL & TANIS, P.C., 2026 RAMBLING ROAD, KALAMAZOO, MI, 49008-1631, US

(21) Appl. No.: 11/221,614

(22) Filed: Sep. 8, 2005

(30) Foreign Application Priority Data
Sep. 14, 2004 (JP) 2004-266453

(51) Int. Cl. H04N 7/16; H04H 9/00

(52) U.S. Cl. 725/14; 725/15

(57) ABSTRACT

The invention provides a tuning apparatus capable of automatically setting a tuning operation efficiently with a simple construction, and a television receiver provided with the same. The microcomputer includes a CPU that performs an operation processing necessary for the control, a channel table that stores selected channel values for one week by each selected time zone as selected channel information, a channel register that counts and stores a set time set to each channel, and a timer that outputs the data of a day of a week and a time; and it counts the set time of each channel by each selected time zone and updates and registers at any time the channel having the longest set time to the channel table as the selected channel value.

### BACKGROUND OF THE INVENTION

1. Field of the Invention

The present invention relates to a tuning apparatus that receives broadcast signals of plural channels such as a TV broadcast and tunes specified channels, and a television receiver provided with the same.

2. Description of the Related Art

There is a trend for multi-channels in the TV broadcasts nowadays. As this trend expands, in the case of selecting a channel of a program that a user wishes to view, it becomes difficult to precisely memorize the very channel among multiple channels. Accordingly, a viewer tries to find out the desired channel by quickly checking a broadcast program guide magazine and so forth. And, as the number of channels increases, the finding out of the desired channel becomes a heavy burden on the viewer.

In order to meet with such circumstances, there have conventionally been proposed improvements and devices whereby the TV receiver automatically performs tuning operations. Such a proposal includes, for example, a tuning operation that reads out channel information having been selected when a power of the TV receiver was disconnected previously, at the current moment of the power being turned on. The patent document 1, JP1994-311443A, discloses a method that updates and stores sequentially each day for one week, reception history data of the channel data viewed by a user, which are associated with the data of a day of a week and a time, and sets a reception channel based on the reception history data corresponding to the data of the day of the week and the time at the moment of the power key being pressed. And, the patent document 2, JP1999-266406A, discloses a method that creates a frequency chart in which reception channels frequently selected by a user are collected, and when there is a channel of a frequency higher than a predetermined one by looking up the frequency chart in the time zone at the power-on time, tunes the channel automatically.

As mentioned above, in cases where the channel set at the previous power-off time is tuned at the power-on time, a program channel viewed in the previous night, for example, is to be tuned at the next morning as it remains intact. Thus, this case involves an imperfection that the program desired by a viewer is not necessarily displayed.

In the patent document 1, when a channel is viewed more than 15 minutes in each time zone, the selected channel is registered together with the tuning start time and the tuning ending time, so that there is a possibility of maximum four channels being selected in each time zone. Accordingly, the memory capacity for storing the reception history data for one week is increased unavoidably. Further, since this method updates the data for one week all at once, when a user is away from home for one week on a trip or the like, it will not properly function in a week next to the week when the user does not view.

In the patent document 2, it is necessary to accumulate and store the past data s as to update the frequency chart, which involves increase of the memory capacity and expansion of system load. Further, since a channel is not tuned if it is not viewed more than the predetermined frequency, it takes time until the latest tuning operation is reflected, which is disadvantageous. And, since a viewer looks up the frequency chart at the power-on time, there is an apprehension that the tuning operation takes time to that extent.

### SUMMARY OF THE INVENTION

Accordingly, it is an object of the present invention to provide a tuning apparatus capable of automatically setting the tuning operation efficiently with a simple construction, and a television receiver provided with the same.

According to one aspect of the invention, the tuning apparatus comprises a reception unit that receives broadcast signals of plural channels, a storage unit that stores selected channel information by each selected time zone on each day of a week, and a control unit that reads out the selected channel information stored in the storage unit and performs a tuning control of the reception unit, wherein the control unit includes time calculation means that counts a set time of a channel by each of the channels selected in the selected time zone on each day of a week, channel determination means that determines a channel having the longest set time on the basis of the set time counted by the time calculation means, and update/register means that registers the channel determined by the channel determination means to the storage unit as selected channel information in the selected time zone. Further, the control unit includes time determination means that determines a day of a week and a time when a power is turned on, discrimination means that discriminates whether the day of a week and the time determined by the time determination means belong to the first half of the selected time zone, and tuning control means that performs the tuning control on the basis of the selected channel information in the selected time zone when the discrimination means discriminates that the day of a week and the time belong thereto, and performs the tuning control on the basis of the selected channel information in a selected time zone next to the selected time zone when the discrimination means discriminates that the day of a week and the time do not belong thereto.

The television receiver according to the invention comprises the tuning apparatus as mentioned above.

The tuning apparatus, having the above construction, updates the selected channel information stored by each selected time zone on each day of a week, on the basis of the channel having the longest set time among the channels selected in the selected time zone on each day of a week. Therefore, the selected channel information is stored one by one by each selected time zone on each day of a week, and a small memory capacity will suffice for this storage. Further, since the selected channel information is always updated on the basis of the latest tuning operation, the tuning operation will automatically be performed in accordance with the current tuning pattern of a viewer. And, since it is updated by each selected time zone, the selected channel information in the selected time zone being not viewed for a while remains without being erased; accordingly, the tuning operation will be automatically performed also to a program, for example, being broadcast at intervals of one month in a midnight time zone.

Further, whether the power-on time belongs to the first half of the selected time zone is judged from the data of a day of a week and a time when the power is turned on; if it belongs to the first half, the tuning operation will be controlled on the basis of the selected channel information in the selected time zone, and if it does not belong to the first half, the tuning operation will be controlled on the basis of the selected channel information in the next selected time zone. Thereby, if a user turns on the power earlier before the start time of the program that the user wishes to view, the channel of the program will be tuned automatically.

### BRIEF DESCRIPTION OF THE DRAWINGS

FIG. 1 is a total block diagram relating to an embodiment according to the present invention;

FIG. 2 is an explanatory chart of a channel table;

FIG. 3 is an explanatory chart of a channel register;

FIG. 4 is a flow chart of an automatic tuning processing;

FIG. 5 is a flow chart of a counting processing in the channel register; and

FIG. 6 is a flow chart of a registering processing of selected channel values in the channel table.

### DETAILED DESCRIPTION OF THE PREFERRED EMBODIMENTS

The embodiments of the present invention will be described in detail with reference to the accompanying drawings. Since the embodiments described hereunder are the preferred examples in working the invention, there are various technical restrictions placed on them. However, the present invention is not restricted to these embodiments, unless there is a clear statement for restricting the invention in the following descriptions.

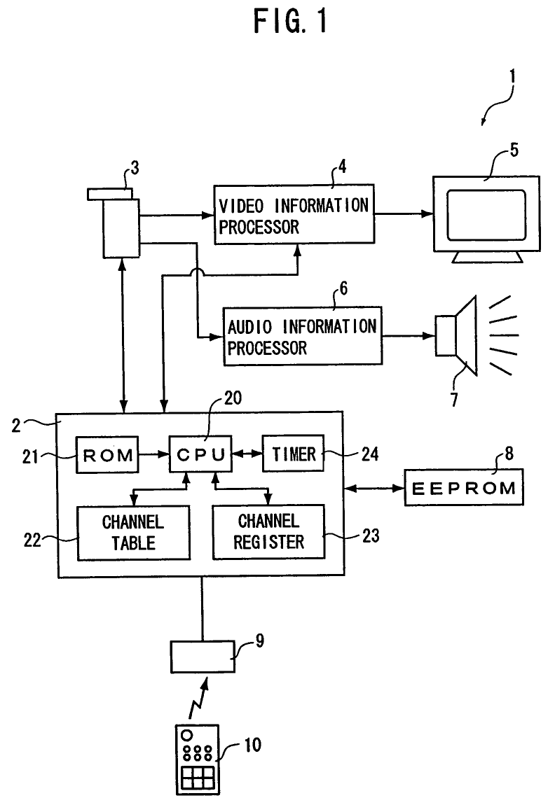

FIG. 1 illustrates the whole construction of an embodiment according to the present invention. ATV receiver 1 includes: a microcomputer 2 that controls the whole apparatus, a tuner 3 that tunes broadcast waves of specified channels out of the broadcast waves received through a TV antenna and extracts video signals and audio signals, a video information processor 4 that processes the video signals extracted and displays video picture on a monitor 5, an audio information processor 6 that processes the audio signals extracted and outputs processed signals to a speaker 7, an EEPROM 8 that stores data and programs required for the initial setting and so forth, and an operation signal receiving unit 9 that receives operation signals from a remote controller 10.

As a user operates the remote controller 10, the operation signal of switching the power on or selection signal of a channel and so forth is transmitted to the operation signal receiving unit 9, and the signal is inputted to the microcomputer 2 from the operation signal receiving unit 9. In the microcomputer 2, a CPU 20 performs a control processing in response to the operation signal.

The microcomputer 2 includes the CPU 20 that performs the operation processing necessary for the control, a ROM 21 that stores image data and so forth necessary for displaying programs and channels, a channel table 22 that stores selected channel values for one week by each selected time zone as the selected channel information, a channel register 23 that counts and stores a set time by each channel, and a timer 24 that outputs the data of a day of a week and a time.

The channel table 22 and the channel register 23 each have storage areas in a RAM. The RAM stores data of the channels that had been tuned when the power was turned off.

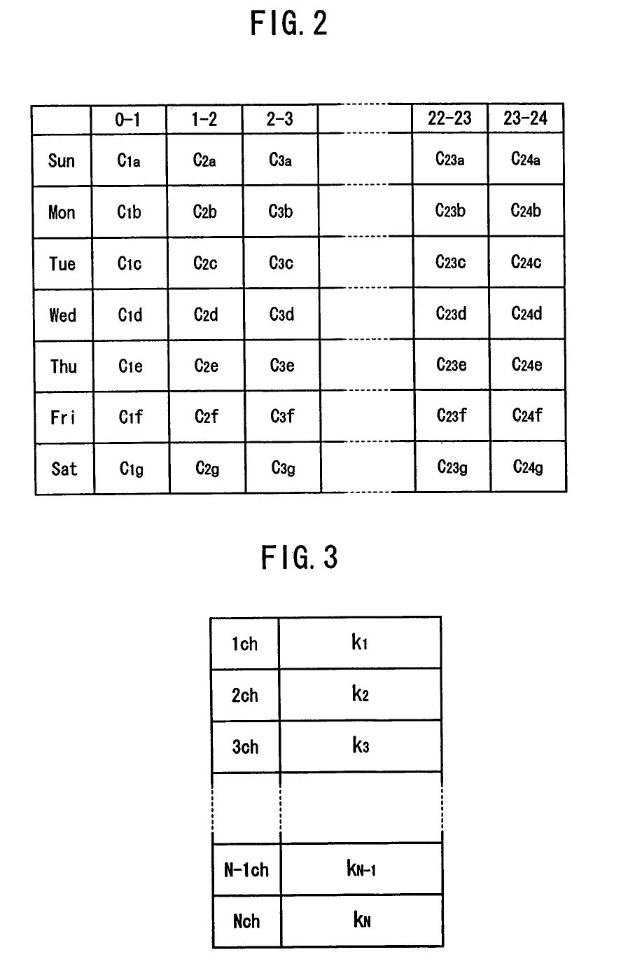

FIG. 2 is a chart explaining the channel table 22. The channel table 22 stores the selected channel values Cₖₐ˜C_{kg} to each of the 24 selected time zones: 0000 hours˜0100 hours, 0100 hours˜0200 hours, . . . , 2200 hours˜2300 hours, 2300 hours˜0000 hours, for one week from Sunday till Saturday. Since one byte suffices for the memory capacity of one selected channel value, the channel table 22 only needs 24×7=168 bytes in total as the memory capacity. If the channel is selected in a selected time zone, the selected channel value is updated on the basis of the channel having the longest time set in the selected time zone.

FIG. 3 is a chart explaining the channel register 23. The channel register 23 stores the count values K₁˜K_{N}, in which the set time in the selected time zone of the channel table 22 is counted every one minutes, by each channel of selectable channels from 1 channel through N channel. And, as the selected time zone shifts, the count values are cleared. In cases where a user starts to view at 0930 hours, for example, the set time is counted every one minutes by each of the channels that are tuned till 1000 hours. As the present time comes to 1000 hours, the selected time zone shifts, accordingly the count values of the channel register 23 are cleared temporarily, and the counting is resumed. Since the count values are cleared by each of the selected time zones, 2 bytes suffice for the memory capacity of one count value, and 2×N bytes suffice for the total memory capacity of the channel register 23.

Since the memory capacity for the channel table 22 and the channel register 23 can be set smaller, as mentioned above, a storage area in the RAM can be used efficiently.

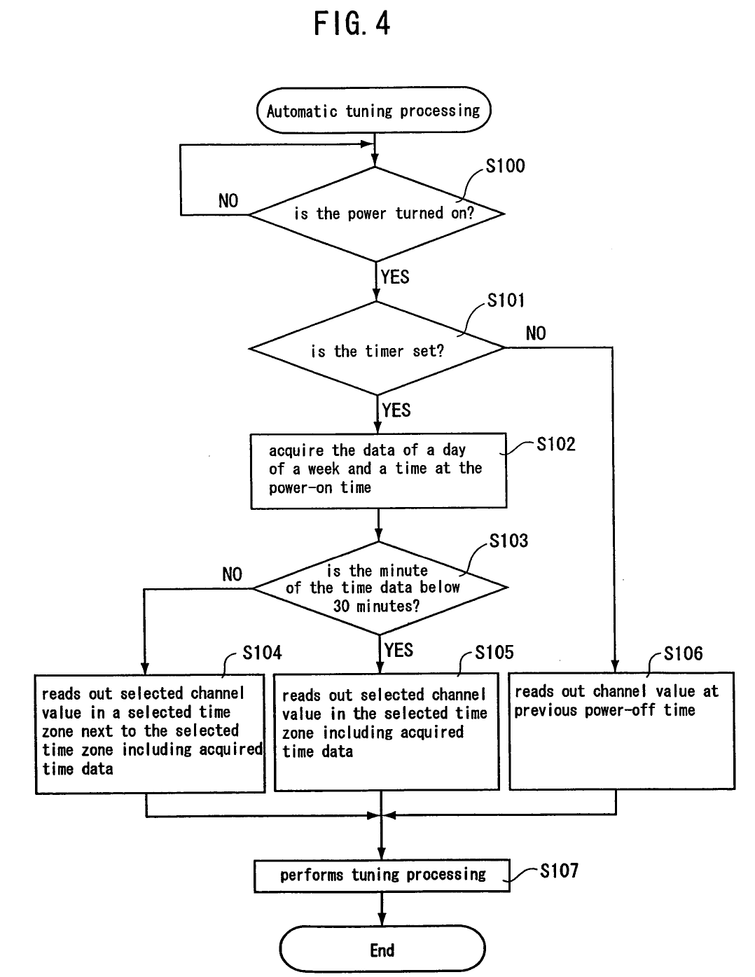

FIG. 4 illustrates a processing flow that performs an automatic tuning at the power-on time. The step S100 checks whether the power is turned on. If the power-on is detected, S101 checks whether the time setting by the timer 24 is performed. If the time setting is performed, S102 acquires the data of a day of a week and a time at the power-on time, from an output signal of the timer 24. The following step S103 checks whether the minutes-data of the time data is below 30 minutes. If the power-on time is 0938 hours, it exceeds 30 minutes, and the judgment is NO; if it is 0924 hours, it is below 30 minutes, and the judgment is YES. Thus, the step S103 discriminates whether the power-on time belongs to the first half of the one hour (till 30 minutes) in the selected time zone.

If S103 judges it below 30 minutes, S105 reads out from the channel table 22, the selected channel value of the selected time zone that includes the acquired data of a day of a week and a time; and S107 performs the tuning processing. If S103 judges that it exceeds 30 minutes, S104 reads out from the channel table 22, the selected channel value of a selected time zone next to the selected time zone that includes the acquired data of a day of a week and a time; and S107 performs the tuning processing. If the power-on time is 0924 hours on Sunday, the selected channel value C₁₀ₐ of the selected time zone 0900 hours˜1000 hours on Sunday is read out, and the microcomputer 2 transmits the control signal to the tuner 3 so as to tune the channel corresponding to the selected channel value C₁₀ₐ. If the power-on time is 0938 hours on Sunday, although the selected time zone is 0900 hours˜1000 hours, the selected channel value C₁₁ₐ of the following selected time zone 1000 hours˜1100 hours on Sunday is read out, and the microcomputer 2 transmits the control signal to the tuner 3 so as to tune the channel corresponding to the selected channel value C₁₁ₐ.

Since the automatic tuning at the power-on time is made in this manner, even in cases where a user turned on the power before the start time of the program that the user wishes to view, the broadcast channel of the program is to be tuned. In most cases, the start time of a program is set, as it starts at just 9 o'clock, for example. Accordingly, a TV viewer is assumed to take a behavior pattern that turns the power on at about 10 minutes before the start time of the program. Therefore, in cases where the present time passes the first half of the selected time zone, if the tuning is performed on the basis of the selected channel value of the next selected time zone, it will be the automatic tuning conforming to the behavior pattern of the viewer.

At step S101, if the time setting is not performed, S106 reads out the channel value when the power was turned off previously; and S107 performs the automatic tuning. It is impossible to acquire the data of a day of a week and a time at the power-on time, in cases where the time setting is not performed; accordingly, the processing after the step S103 cannot be performed. Thus, the automatic tuning is performed by using the channel value at the previous power-off time.

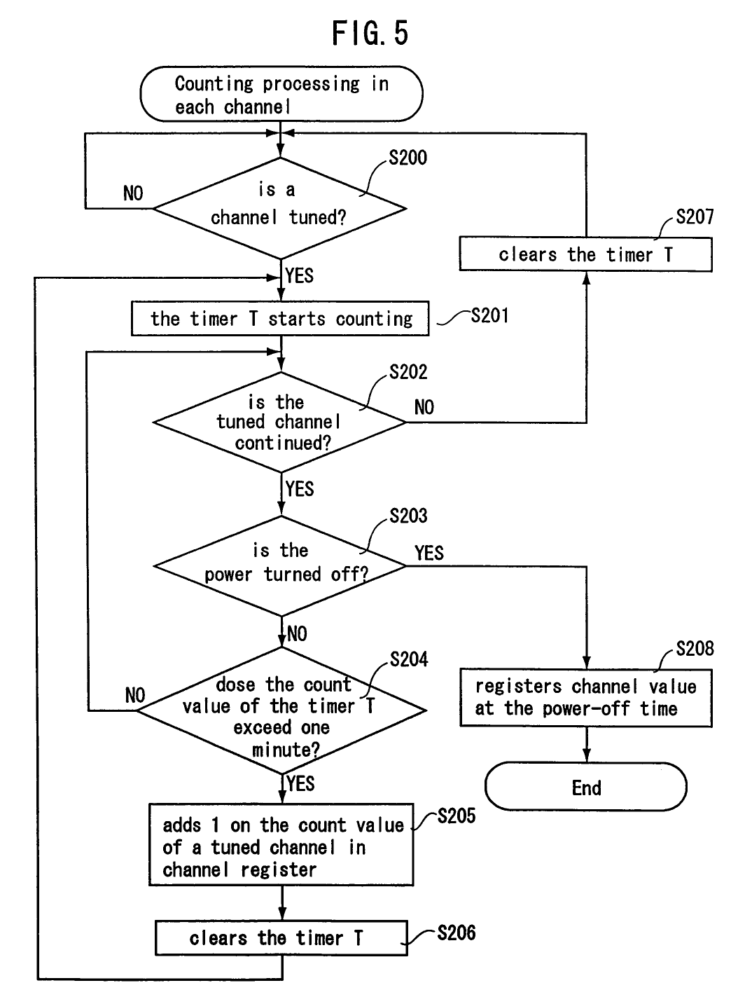

FIG. 5 illustrates a processing flow that counts the set time by each channel in each selected time zone. The first step S200 checks whether a channel is tuned; if the channel is tuned, the timer T starts counting at S201. And, S202 checks whether the tuned channel is continued. If it is continued, S203 checks whether the power is turned off. If the power is not turned off, S204 checks whether the count value of the timer T exceeds one minute. If it does not exceed one minute, the step returns to S202. If it exceeds one minute, S205 adds 1 on the count value relating to the channel now being tuned, contained in the channel register 23. And, the next step S206 clears the timer T, and returns to S201. Thus, the set time of the tuned channel is counted in units of minutes in the channel register 23.

If the channel is switched, S202 judges that the channel is not continued; S207 clears the timer T, and returns to S200. And, an adding processing of the count value is performed to a newly tuned channel.

If the power is turned off, S208 stores the channel value of the channel being tuned at the power-off time in the RAM, and ends the processing.

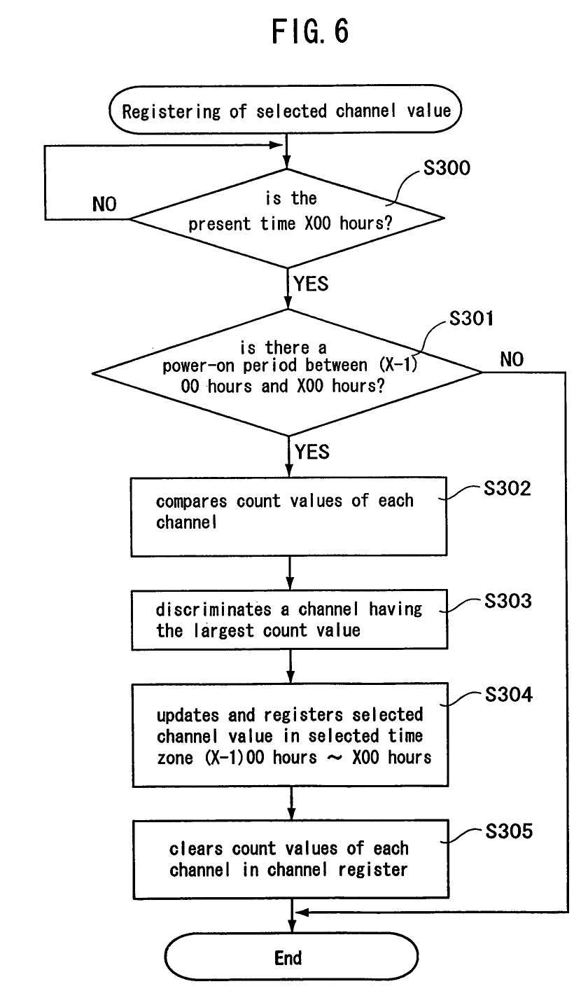

FIG. 6 illustrates a processing flow that updates and registers the selected channel values in the channel table, on the basis of the count values in the channel register 23 that are counted as above. The first step S300 checks the output signal of the timer 24, and checks whether the present time is X00 hours being the ending time in the selected time zone (X−1) 00 hours˜X00 hours. As it reaches X00 hours, S301 checks whether there is a period during which the power is turned on between (X−1) 00 hours and X00 hours. If there is the period during which the power is turned on, since the count value with the set time counted at the tuning is stored in the channel register 23, S302 reads out the count values of each channel and compares them. On the basis of the comparison result, S303 discriminates a channel having the largest count value. Since the count value of each channel has the set time counted in units of minutes, the channel having the largest count value is the channel having the longest set time in that selected time zone.

On the basis of the channel discriminated, S304 updates and registers, in the channel table 22, a selected channel value C in the selected time zone (X−1) 00 hours˜X00 hours on the present day of the week. And, S305 clears all the count values contained in the channel register 23, and ends the processing. Here, if the step S301 judges that there is not the period during which the power is turned on, the step ends there.

As described above, the selected channel values in the channel table 22 are updated in real time in correspondence with the real circumstances of the present tuned channels; therefore, it is possible to always register the latest channel that a viewer selects. Accordingly, the automatic tuning at the power-on time is to be performed in accordance with the latest tuning pattern of a viewer, which relieves the viewer of the burden of the tuning operations. Further, in regard to a program in the time zone that a user does not usually view, if the user views it once, the selected channel value thereof will be registered in the channel table 22, and the data will not be erased until it is viewed next; therefore, in cases where a user views a midnight program that the user does not usually view on a one-month cycle, for example, the program is automatically tuned at the power-on time.

1. A tuning apparatus comprising:
a reception unit for receiving broadcast signals of plural channels;
a storage unit for storing selected channel information by each selected time zone on each day of a week; and
a control unit for reading out the selected channel information stored in the storage unit and performs a tuning control of the reception unit;
wherein the control unit includes time calculation means for counting a set time of a channel by each of the channels selected in the selected time zone on each day of a week, channel determination means for determining a channel having the longest set time on the basis of the set time counted by the time calculation means, and update/register means for registering the channel determined by the channel determination means to the storage unit as selected channel information in the selected time zone.

2. A tuning apparatus according to claim 1, wherein the control unit includes time determination means for determining a day of a week and a time when a power is turned on, discrimination means for discriminating whether the day of a week and the time determined by the time determination means belong to the first half of the selected time zone, and tuning control means for performing the tuning control on the basis of the selected channel information in the selected time zone when the discrimination means discriminates that the day of a week and the time belong thereto, and performs the tuning control on the basis of the selected channel information in a selected time zone next to the selected time zone when the discrimination means discriminates that the day of a week and the time do not belong thereto.

3. A television receiver provided with the tuning apparatus according to claim 1.
